(19) United States
(12) Patent Application Publication
(10) Pub. No.: US 2018/0184701 A1
(43) Pub. Date: Jul. 5, 2018

(54) JUICE EXTRACTION MODULE FOR LARGE-CALIBER JUICER

(71) Applicant: Jianjun LIU, Zhoushan City (CN)

(72) Inventor: Jianjun LIU, Zhoushan City (CN)

(21) Appl. No.: 15/802,217

(22) Filed: Nov. 2, 2017

(30) Foreign Application Priority Data
Jan. 5, 2017 (CN) 201720010587.3

(51) Int. Cl. A23N 1/02

(52) U.S. Cl. CPC A23N 1/02

(57) ABSTRACT

A juice extraction module for a large-caliber juicer includes a base, a hood body, a rotary brush, a juicing net and a helical structure, wherein the hood body is matched with the base; the rotary brush, the juicing net and the helical structure are accommodated in a housing formed by matching the base and the hood body; the helical structure is accommodated in the juicing net; the juicing net is accommodated in the rotary brush and an outer wall of the juicing net is fitted with an inner wall of the rotary brush. An extrusion part is arranged on the helical structure of the juice extraction module for the large-caliber juicer in the utility model. Helical vanes are arranged at the periphery of the extrusion part. Outer diameters of the helical vanes are consistent from top to bottom. A cutting part is arranged at a top of the extrusion part. The cutting part firstly cuts fruits and vegetables into small blocks; the helical vanes continuously deliver the small blocks of the fruits and vegetables downwards and extrude the small blocks, so as to realize quick juicing, thereby effectively preventing the fruits and vegetables from accumulating in a feed inlet and increasing juicing efficiency.

### TECHNICAL FIELD

The utility model relates to a juice extraction module for a large-caliber juicer.

### BACKGROUND

An existing juicer solves the problems of extrusion and crushing of material by means of the characteristic that the material flows downwards through self gravity. Meanwhile, because a machine base is arranged on a bottom, stability of a machine is good. However, a material inlet in the above solution is arranged above a screw rod. After entering a shell, the material falls above a helix of the screw rod and is difficult to feed. Meanwhile, if the material falls in a position near an axis, because rotating speed in the position of the axis is zero, feeding is slow and the material may be accumulated, thereby affecting next extrusion and crushing.

### SUMMARY

The utility model provides a juice extraction module for a juicer with high feeding speed and high juicing efficiency.

A technical solution adopted to solve the above technical problems in the utility model is as follows:

A juice extraction module for a large-caliber juicer comprises a base, a hood body, a rotary brush, a juicing net and a helical structure, wherein the hood body is matched with the base; the rotary brush, the juicing net and the helical structure are accommodated in a housing formed by matching the base and the hood body; the helical structure is accommodated in the juicing net; the juicing net is accommodated in the rotary brush and an outer wall of the juicing net is fitted with an inner wall of the rotary brush, wherein an extrusion part is arranged on the helical structure; a juicing processing position is arranged at the bottom of the hood body; the juicing processing position accommodates the extrusion part of the helical structure; an outer wall of the juicing processing position is an arc-shaped surface; the radius of the arc-shaped surface is consistent from top to bottom; a cutting part is arranged at an upper part of the extrusion part; the cutting part is a blade; helical vanes are arranged at the periphery of the extrusion part from top to bottom; and outer diameters of the helical vanes are consistent from top to bottom.

Preferably, an axis of the helical structure is opposite to the bottom of the hood body.

Preferably, a juice outlet and a residue outlet are arranged on the outer contour of the bottom of the base; and a sealing cover is arranged on the juice outlet.

Preferably, a safety cover is arranged on a top of the hood body; and a cover body hinged and matched with the safety cover is arranged on the safety cover.

Preferably, first teeth are arranged on the circumferential bottom of the rotary brush; second teeth and a driving shaft are arranged on the bottom of the helical structure; the driving shaft is located at a center of a circle of the bottom of the helical structure; the second teeth are arranged at an outer edge of the bottom of the helical structure; a gear is arranged between the first teeth and the second teeth; and the gear is engaged with the first teeth and the second teeth.

Preferably, a diameter of the juicing net is gradually decreased from top to bottom.

Compared with the prior art, an extrusion part is arranged on the helical structure of the juice extraction module for the large-caliber juicer in the utility model. Helical vanes are arranged at the periphery of the extrusion part. Outer diameters of the helical vanes are consistent from top to bottom. A cutting part is arranged at a top of the extrusion part. The cutting part firstly cuts fruits and vegetables into small blocks; the helical vanes continuously deliver the small blocks of the fruits and vegetables downwards and extrude the small blocks, so as to realize quick juicing, thereby effectively preventing the fruits and vegetables from accumulating in a feed inlet and increasing juicing efficiency.

### DESCRIPTION OF DRAWINGS

FIG. 1 is a structural view of a juice extraction module for a large-caliber juicer in the utility model;

FIG. 2 is a local structural view of a juice extraction module for a large-caliber juicer in the utility model;

FIG. 3 is an exploded view of a juice extraction module for a large-caliber juicer in the utility model;

FIG. 4 is a first structural view of a juice extraction module for a large-caliber juicer in the utility model; and

FIG. 5 is a second structural view of a juice extraction module for a large-caliber juicer in the utility model.

### DETAILED DESCRIPTION

The utility model is further described below in detail in combination with the drawings and embodiments.

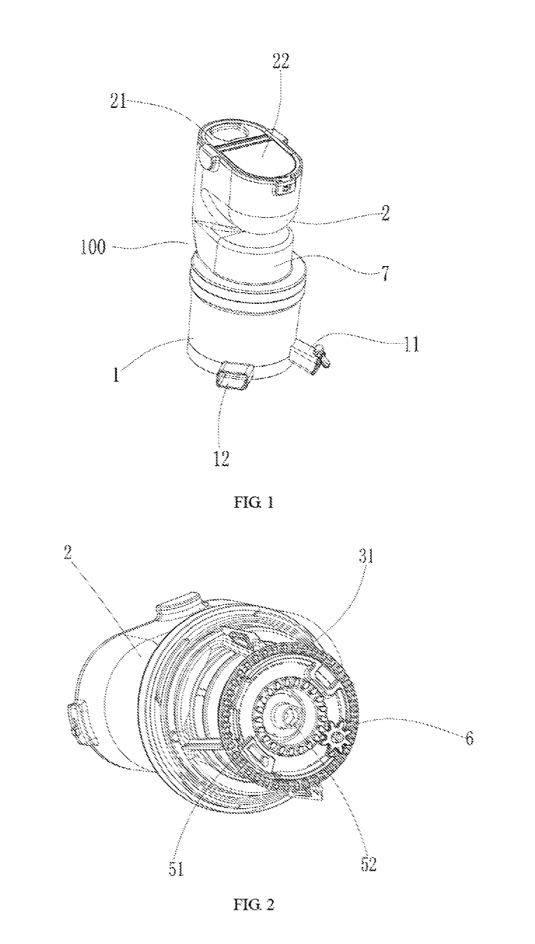

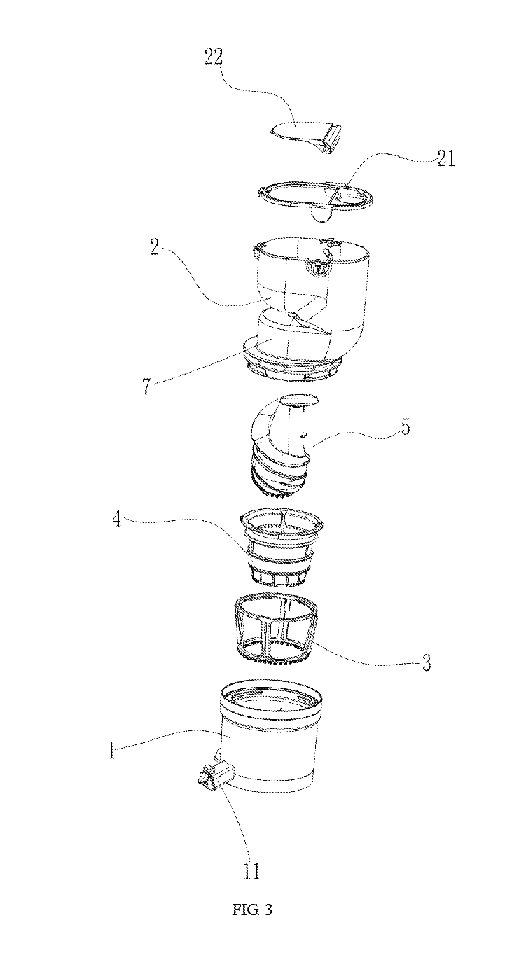

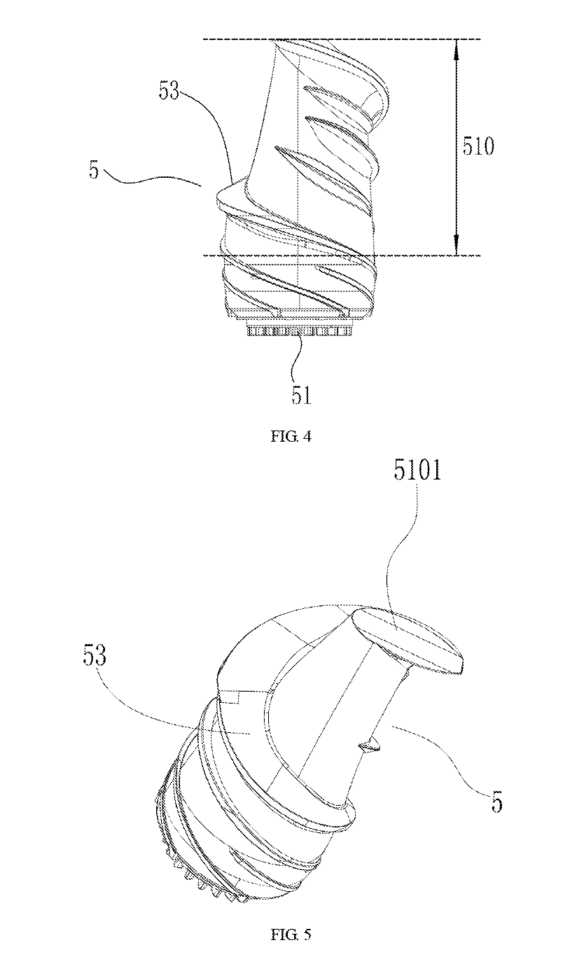

As shown in FIG. 1 to FIG. 5, the juice extraction module 100 for the juicer comprises a base 1, a hood body 2, a rotary brush 3, a juicing net 4, a helical structure 5 and a gear 6. The hood body 2 is arranged on the base 1. The rotary brush 3, the juicing net 4 and the helical structure 5 are accommodated in a space formed by matching the base 1 and the hood body 2. The helical structure 5 is accommodated in the juicing net 4. The juicing net 4 is accommodated in the rotary brush 3 and an outer wall of the juicing net 4 is fitted with an inner wall of the rotary brush 3. A juice outlet 11 and a residue outlet 12 are arranged on the circumferential surface of the bottom of the base 1, and a sealing cover is arranged on the juice outlet 11. A safety cover 21 is arranged on a top of the hood body 2. A cover body 22 hinged and matched with the safety cover 21 is arranged on the safety cover 21. An axis of the helical structure 5 is opposite to the center of the bottom of the hood body 2. An extrusion part 510 is arranged on the helical structure 5. A juicing processing position 7 is arranged at the bottom of the hood body 2. The juicing processing position 7 accommodates the extrusion part 510 of the helical structure 5. A cutting part 5101 is arranged at an upper part of the extrusion part 510. The cutting part 5101 is a blade. First teeth 31 are arranged on the circumferential bottom of the rotary brush 3. Second teeth 51 are arranged on an outer surface of the bottom of the helical structure 5. A driving shaft 52 is located at a center of the bottom of the helical structure 5. Helical vanes 53 arranged along the periphery of the extrusion part 510 from top to bottom are installed on an outer wall of the helical structure 5. Outer diameters of the helical vanes 53 are consistent from top to bottom. A gear 6 is arranged between the first teeth 31 and the second teeth 51, and the gear 6 is engaged with the first teeth 31 and the second teeth 51.

An outer wall of the juicing processing position 7 is an arc-shaped surface, and the radius of the arc-shaped surface is consistent from top to bottom. The juicing processing position 7 is formed so that a bottom region of the feed inlet is covered at a height that the juicing processing position 7 is connected with the bottom of the feed inlet of the hood body 2. An inner surface of the juicing processing position 7 comprises a food material guiding surface and extends from the feed inlet. The food material guiding surface guides the material in this manner, so that a side surface of the food material is squeezed by the helical vanes 53.

In a process of juicing, firstly, the juice extraction module 100 for the juicer is put on a power supply base; a driving bearing which extends upwards is arranged on the power supply base; the driving bearing is matched with an electric motor in the power supply base; and therefore, the driving shaft 52 on the bottom of the helical structure 5 is matched with the driving bearing on the power supply base. The safety cover 21 of the hood body 2 is opened and food materials, such as fruits, vegetables, etc., are put into the safety cover 21. After the safety cover 21 is closed, a power supply switch on the power supply base is pressed; the electric motor is started; and the helical structure 5 is driven by the driving bearing to rotate. Because the first teeth 31 and the second teeth 51 are simultaneously engaged with the gear 6, the rotary brush 3 is driven by the gear 6 to rotate in the rotating process of the helical structure 5. As the helical structure 5 is continuously rotated, the cutting part 5101 firstly cuts the food materials into small blocks. Because the diameter of the juicing net 4 is gradually decreased from top to bottom, a gap between the outer wall of the helical structure 5 and the juicing net 4 is gradually decreased from top to bottom, so that the helical vanes 53 of the helical structure 5 and the juicing net 4 continuously extrude and squeeze the fruits and the vegetables. The squeezed juice exudes through holes in the juicing net 4. The rotary brush 3 continuously rotates and scrape down fruit juice on the outer wall of the juicing net 4. Finally, the fruit juice flows out through the juice outlet 11, while residues formed after squeezing are discharged through the residue outlet 12.

The extrusion part 510 is arranged on the helical structure 5 of the juice extraction module 100 for the large-caliber juicer in the utility model. The helical vanes 53 are arranged at the periphery of the extrusion part 510. Outer diameters of the helical vanes 53 are consistent from top to bottom. A cutting part 5101 is arranged at a top of the extrusion part 510. The cutting part 5101 firstly cuts fruits and vegetables into small blocks; the helical vanes 53 continuously deliver the small blocks of the fruits and vegetables downwards and extrude the small blocks, so as to realize quick juicing, thereby effectively preventing the fruits and vegetables from accumulating in the feed inlet and increasing juicing efficiency.

Finally, it should be noted that the above embodiments are only used for describing the technical solution of the utility model rather than limitation. Although the utility model is described in detail by referring to the above embodiments, those ordinary skilled in the art should understand that: the technical solution recorded in each of the above embodiments can be still amended, or some technical features therein can be replaced equivalently. However, these amendments or replacements do not enable the essence of the corresponding technical solution to depart from the spirit and the scope of the technical solution of various embodiments of the utility model.

1. A juice extraction module for a large-caliber juicer, comprising a base (1), a hood body (2), a rotary brush (3), a juicing net (4) and a helical structure (5), wherein the hood body (2) is matched with the base (1); the rotary brush (3), the juicing net (4) and the helical structure (5) are accommodated in a housing formed by matching the base (1) and the hood body (2); the helical structure (5) is accommodated in the juicing net (4); the juicing net (4) is accommodated in the rotary brush (3) and an outer wall of the juicing net (4) is fitted with an inner wall of the rotary brush (3), wherein an extrusion part (510) is arranged on the helical structure (5); a juicing processing position (7) is arranged at the bottom of the hood body (2); the juicing processing position (7) accommodates the extrusion part (510) of the helical structure (5); an outer wall of the juicing processing position (7) is an arc-shaped surface; the radius of the arc-shaped surface is consistent from top to bottom; a cutting part (5101) is arranged at an upper part of the extrusion part (510); the cutting part (5101) is a blade; helical vanes (53) are arranged at the periphery of the extrusion part (510) from top to bottom; and outer diameters of the helical vanes (53) are consistent from top to bottom.

2. The juice extraction module for the large-caliber juicer according to claim 1, wherein an axis of the helical structure (5) is opposite to the bottom of the hood body (2).

3. The juice extraction module for the large-caliber juicer according to claim 1, wherein a juice outlet (11) and a residue outlet (12) are arranged on the outer contour of the bottom of the base (1); and a sealing cover is arranged on the juice outlet (11).

4. The juice extraction module for the large-caliber juicer according to claim 1, wherein a safety cover (21) is arranged on a top of the hood body (2); and a cover body (22) hinged and matched with the safety cover (21) is arranged on the safety cover (21).

5. The juice extraction module for the large-caliber juicer according to claim 1, wherein first teeth (31) are arranged on the circumferential bottom of the rotary brush (3); second teeth (51) and a driving shaft (52) are arranged on the bottom of the helical structure (5); the driving shaft (52) is located at a center of a circle of the bottom of the helical structure (5); the second teeth (51) are arranged at an outer edge of the bottom of the helical structure (5); a gear (6) is arranged between the first teeth (31) and the second teeth (51); and the gear (6) is engaged with the first teeth (31) and the second teeth (51).

6. The juice extraction module for the large-caliber juicer according to claim 1, wherein a diameter of the juicing net (4) is gradually decreased from top to bottom.
